(19) United States
(12) Patent Application Publication
(10) Pub. No.: US 2025/0216255 A1
(43) Pub. Date: Jul. 3, 2025

(54) APPARATUS AND METHOD FOR SPECTRUM DETECTION BY DEFECT SCATTERING CALCULATION AND RECONSTRUCTION

(71) Applicant: NANJING INSTITUTE OF ASTRONOMICAL OPTICS & TECHNOLOGY, CHINESE ACADEMY OF SCIENCES, Jiangsu (CN)

(72) Inventors: Jinping HE, Jiangsu (CN); Zhenning ZHAO, Jiangsu (CN); Xue TONG, Jiangsu (CN)

(21) Appl. No.: 18/848,332

(22) PCT Filed: Dec. 12, 2023
(86) PCT No.: PCT/CN2023/138072

§ 371 Date: Sep. 18, 2024

(30) Foreign Application Priority Data
Feb. 15, 2023 (CN) 202310113989.6

(51) Int. Cl. G01J 3/02; G01J 3/28; G01N 21/88; G01N 21/95

(52) U.S. Cl. CPC G01J 3/0259; G01J 3/0208; G01J 3/2803; G01N 21/8806; G01N 21/9501; G01J 2003/2833; G01J 2003/284

(57) ABSTRACT

An apparatus and method for spectrum detection by defect scattering calculation and reconstruction. The apparatus includes a photodetector, a light input system, a multi-mode waveguide, a random defect scattering structure and a substrate. The defect scattering structure is a recess with random quantities of size and position on the surface of the optical waveguide. The technical solution reconstructs a target spectrum by introducing random defects onto the surface of the optical waveguide to obtain scattered light, has the advantages of fewer devices, compact spatial optical path and small size compared with the traditional commercial spectrometer, effectively reduces the system complexity and cost of the spectrometer, and improves the portability of the spectrometer. This structure can reproduce an incidence spectrum well when using the calculation and reconstruction method to reconstruct the spectrum, and has a large bandwidth and high spectral resolution.

### TECHNICAL FIELD

The present invention relates to the technical field of spectrometers, in particular to an apparatus and method for spectrum detection by defect scattering calculation and reconstruction.

### BACKGROUND ART

Spectral analysis is important technical means to observe the structures and components of substances, and is widely used in physics, chemistry, astronomy, biomedicine, environmental detection, communication, national defense security, and many other scientific research and industrial and agricultural production fields.

Existing general-purpose spectrometers are mainly based on grating dispersion and Fourier transform, and thus are generally expensive to manufacture and maintain, large in size, and limited in many application fields, e.g., some functionalized optoelectronic chips and instruments that require extremely compact spectroscopic instruments.

In recent years, various micro-nano spectroscopic technologies and chips have been widely studied, e.g., standing wave interferometer Fourier transform spectrometer SWIFTS, etc. These spectroscopic chips and instruments have almost no discrete components, have extremely small size, stable structure and low cost, and are expected to become the most important option for the next generation of spectroscopic technologies and instruments.

### SUMMARY OF THE INVENTION

In order to solve the above problems, the present invention proposes an apparatus and method for spectrum detection by defect scattering calculation and reconstruction. According to the present invention, surface defects are used to obtain scattered light, spectral reconstruction is used to obtain a target spectrum, and the reconstructed spectrum has high resolution and fast speed. No grating prism filter and other light-splitting elements is used, so few devices are used, the spatial optical path is compact, and the size is small and even close to none, thereby solving the defects that the traditional spectrometers have high requirements for the precision of optical components, large size, high cost and inconvenience to carry.

The technical solution adopted by the present invention is as follows: an apparatus for spectrum detection by defect scattering calculation and reconstruction includes a light scattering system and a detection system, wherein the light scattering system includes light input system, a multi-mode waveguide and a surface random defect scattering array; the detection system is a photodetector; and the photodetector is arranged on the optical waveguide and is used to detect scattered light.

Preferably, the light input system is a single-mode waveguide, wherein the width of the single-mode waveguide satisfies that light propagation on an operating band of a spectrometer is single-mode, the thickness of the single-mode waveguide is the same as the width, and the length of the single-mode waveguide can ensure that the light is stable for single-mode propagation in the propagation process, so as to maintain the stability of an input light field.

Preferably, the single-mode waveguide is made of a transparent material or a low-absorption material in the operating band, and the material of the single-mode waveguide is optionally silicon nitride in the present invention, but is not limited to the use of silicon, silicon dioxide, lithium niobate, III-V semiconductor compounds or polymer material.

Preferably, the optical waveguide region is a flat multi-mode waveguide; and the multi-mode interference mainly occurs in a transverse direction of the waveguide. The multi-mode waveguide is made of the same material as the single-mode waveguide. Silicon nitride is selected as the material in the present invention. The material of the waveguide is a transparent material in the operating band, which is silicon nitride, but not limited to silicon, silicon dioxide, lithium niobate, III-V semiconductor compounds or polymer material.

Preferably, the defects are of a random defect array; a basic unit of each defect is circular, but not limited to be circular, or may be hexagonal, pentagonal, quadrilateral, cross-shaped, triangular or other regular or irregular shapes, preferably circular; and the defect is manifested as a spherical shape on a three-dimensional scale.

Preferably, a radius of each defect is a random value; a basic array of the defects is an N×M array, which is tiled on the upper surface of the entire multi-mode waveguide; the position of each basic unit also has a random quantity in a length direction and a random quantity in a width direction of the multi-mode waveguide; the random quantity refers to a random deviation near array points which are originally regular; and the range of this deviation does not exceed a distance between the two adjacent defects of the basic array. The spherical centers of the defects are all located on the surface of the multi-mode waveguide; each defect is manifested as a hemispherical recess on the surface of the waveguide; and light is scattered from the defect.

A method for spectrum detection by defect scattering calculation and reconstruction includes the following steps:
1) calibration: allowing a number of calibration light of known wavelengths and intensities in a band range to enter a device, and the light being scattered from the side surface of the optical waveguide to obtain a light field intensity distribution on different pixels of the photodetector; storing intensity values obtained by this series of different wavelengths in a transmission matrix as a spectral response function;
2) collection of a scattered light field intensity distribution on the side surface: when light of an unknown spectrum enters the device, the light being scattered from the side surface of the optical waveguide to obtain a light field intensity distribution on the photodetector; and
3) spectral reconstruction: a calibrated transmission matrix and a light field distribution of unknown light forming a linear equation, and a spectrum of reconstructed light to be measured being obtained by solving the linear equation.

Preferably, the photodetector collects an optical signal scattered from the side surface of the optical waveguide.

Preferably, an equation used in the spectral reconstruction process is as follows:

$$I ( x ) = \int T ( x , λ ) S ( λ ) d λ .$$

In the above formula:
S(λ) represents a spectral component matrix of input light;
T(x,λ) represents a transmission matrix of the device, i.e., a spectral response matrix of a device to be calibrated; and
I(x) represents a light field intensity distribution matrix obtained at different positions of the detector.

This equation may be expanded to obtain:

$$( \begin{matrix}{T}_{11} & … & {T}_{m 1} \\ ⋮ & ⋱ & ⋮ \\ {T}_{1 n} & … & {T}_{mn}\end{matrix} ) [ \begin{matrix}{S}_{1} \\ ⋮ \\ {S}_{m}\end{matrix} ] = [ \begin{matrix}{I}_{1} \\ ⋮ \\ {I}_{n}\end{matrix} ] .$$

Preferably, the detailed steps of the spectral reconstruction process are as follows:
1. calibrating and obtaining transmittance functions Tn at different positions of the device, Tn being a transmittance function of an n^{th} spatial spot channel; continuously adjusting a wavelength S of incident light, and obtaining m Tn sampled at an equal wavelength interval, these Tn constituting a transmission matrix T(n,m) of the device, which describes the spectral response of the device, and T(n,m) being a two-dimensional matrix:

$$T = ( \begin{matrix}{T}_{11} & … & {T}_{m 1} \\ ⋮ & ⋱ & ⋮ \\ {T}_{1 n} & … & {T}_{mn}\end{matrix} )$$

2. measuring a device response of light to be measured; introducing the unknown light into the light input system, wherein the light may be scattered from the defect in the optical waveguide region after being propagated to the optical waveguide region, forming a spot; obtaining the intensity In of the spot on the photodetector, In being the light field intensity of the n^{th} pixel point on the photodetector corresponding to the n^{th} spatial spectral channel, and the light field intensity distribution I being a one-dimensional matrix having a length n:

$$I = [ \begin{matrix}{I}_{1} \\ ⋮ \\ {I}_{n}\end{matrix} ]$$

3. solving an unknown spectrum, the unknown spectrum S being obtained by solving a linear equation set S=T⁻¹I. S is a matrix having a length m:

$$S = [ \begin{matrix}{S}_{1} \\ ⋮ \\ {S}_{m}\end{matrix} ] .$$

Preferably, m≥n.

The present invention has the following beneficial effects: when the apparatus for spectrum detection by defect scattering calculation and reconstruction of the present invention is in use, a detection region can be selected reasonably to operate in different bands for detection. Because the optical waveguide is used as a main structure, the size of the device is small, only a few square millimeters, so the size of the spectrometer can be reduced. The used defects have no high requirements for shapes and positions, which are all added with random quantities, so the precision requirements for manufacturing are not high. Because a large number of random defects are used, the interference introduced by multi-mode interference is enough to cause the device to have a sensitive spectral response, which makes the device achieve high resolution and small size, and also can meet the high-precision measurement. In addition, through the integration of the detector and the device, movable components of the device are reduced, the integration and stability of the device are greatly improved, which greatly improves the integration level and stability of the device. The device has relatively large characteristic structure, is suitable for mass production, reduces the manufacturing cost of the device, and avoids the defects of the traditional spectrometer such as high precision requirements, large size, high cost and inconvenience to carry.

### BRIEF DESCRIPTION OF THE DRAWINGS

FIG. 1 is a schematic structural diagram of an apparatus for spectrum detection by defect scattering calculation and reconstruction provided by an embodiment of the present invention.

FIG. 2 is a diagram of a random defect scattering structure provided by an embodiment of the present invention.

FIG. 3 is a spectral response diagram of defects at different positions provided by an embodiment of the present invention.

FIG. 4 is a schematic diagram of a broadband continuous spectrum and an incidence spectrum recovered from the reconstruction according to an embodiment of the present invention.

FIG. 5 is a schematic diagram of a broadband equispaced spectrum and an incidence spectrum recovered from the reconstruction according to an embodiment of the present invention.

FIG. 6 is a minimum resolvable bispectral line recovered from the reconstruction according to an embodiment of the present invention.

In the drawings, symbols represent the following components: 1-photodetector; 2-light input system; 3-multi-mode waveguide; 4-random defect scattering structure; 5-substrate.

### DETAILED DESCRIPTION OF THE INVENTION

The present invention will be further described below in conjunction with the specific embodiments.

The present invention is not limited to the following specific implementations. It should be understood that the following specific embodiments are only demonstrative descriptions and elaborations of the present invention, and do not limit the protection scope of the present invention. Any simple change or alteration that adopts the design structure and ideas of the present invention falls within the protection scope of the present invention.

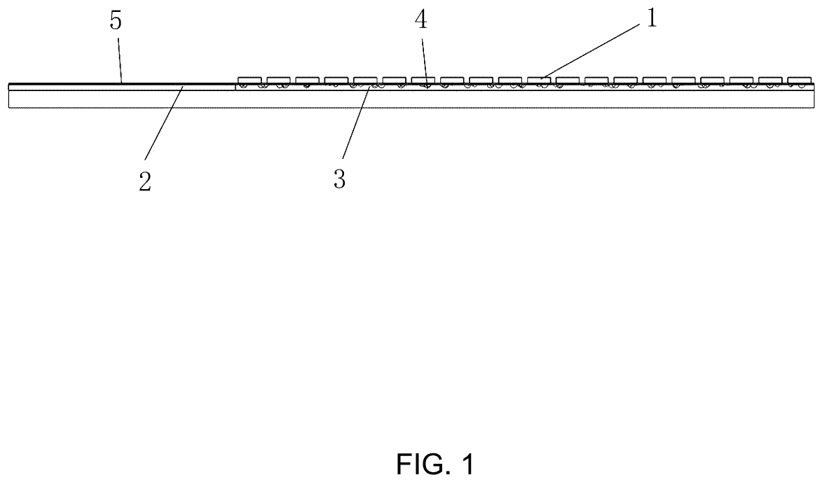

As shown in FIG. 1, the specific structure of a specific embodiment of the present invention is shown. The present invention provides an apparatus for spectrum detection by defect scattering calculation and reconstruction, which is mainly composed of a photodetector 1, light input system 2, a multi-mode waveguide 3, a random defect scattering structure 4 and a substrate 5. The light input system 2 is connected to the optical waveguide 3, and the photodetector 1 is positioned directly above the multi-mode waveguide 3.

When in use, the light input system is used as a single-mode waveguide. The incident light is coupled through an optical fiber lens. The incident light is stabilized as single-mode light after being propagated through the single-mode waveguide, and then enters the optical waveguide 3. The optical waveguide is a multi-mode waveguide. In the multi-mode waveguide, the light interferes in the multi-mode waveguide, and is then scattered from the random defect scattering structure 4. A defect scattering unit further influences the propagation of the light in the optical waveguide, and then shows a sensitive spectral response in a scattered spot within the subsequent range of the multi-mode waveguide. The scattered spot is received by the photodetector 1. After a device is calibrated, a spectrum of unknown light can be obtained by using a spot generated by the unknown light through a reconstruction algorithm.

In a specific embodiment, silicon nitride is selected as both the material of the single-mode waveguide and the material of the multi-mode waveguide. In addition to the silicon nitride, a material which keeps transparent in an operating band of an instrument may also be used. For example, if it is used near the infrared wavelength, the waveguide may also be made of silicon. A sectional dimension of the single-mode waveguide is 0.2 μm×0.2 μm, and the length of the single-mode waveguide is 100 μm, which is intended to keep the input light stable in the operating band of the device. The operating band of the device is 0.6-1.6 μm. Within the operating band range, the single-mode waveguide can make the input light of all wavelengths be transformed into single-mode through the coupling into the single-mode waveguide and then propagated, so as to maintain the stability of an input spot when the multi-mode waveguide is input, thereby enhancing the response stability of the device to each wavelength.

A sectional dimension of the multi-mode waveguide is 0.5 μm×8 μm, and the length of the waveguide is 4500 μm. Light is introduced from the single-mode waveguide and then interferes in the multi-mode waveguide. Interference patterns of light of different wavelengths are different. After the light is introduced into randomly distributed defects, the difference between the interference patterns of light of different wavelength is more obvious. The multi-mode waveguide is taken as a carrier for random defect scattering.

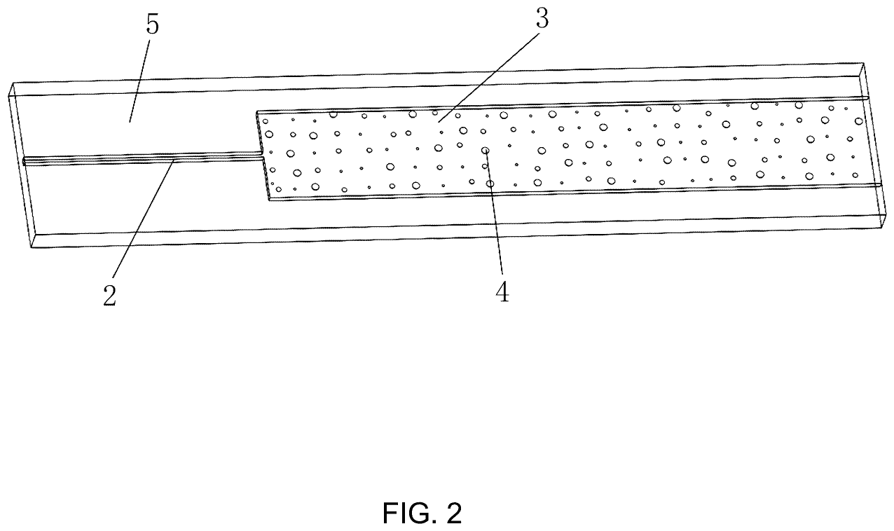

As shown in FIG. 2, in the random defect scattering structure, a basic unit of each defect is circular, but not limited to be circular, or may be hexagonal, pentagonal, quadrilateral, cross-shaped, triangular, etc., preferably circular. The defect is manifested as a spherical shape on a three-dimensional scale.

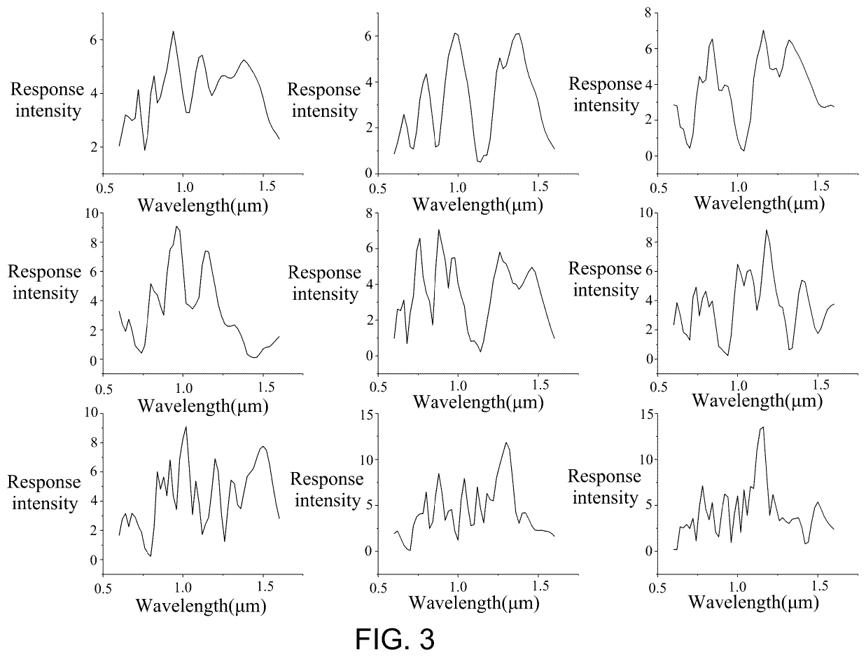

As shown in FIG. 3, when the random defect structures are distributed at different positions of the multi-mode waveguide, different spectral responses will be reflected. When light is propagated in the multi-mode waveguide, the random defect structure will scatter different spectral responses, while this structure may also affect the next propagation of light in the multi-mode waveguide, thereby increasing the spectral sensitivity of the corresponding defect structure.

The radius of the defect is 0.1-0.3 μm randomly, and a basic array of the defect is a 5×1000 array, but the number is not limited to 5×1000. When in actual use, in order to cover the surface of the entire multi-mode waveguide, 1.5 basic arrays are used, and the total number of the defects is 5×1500. Array units are arranged at an interval of 1.6 μm in a width direction and are uniformly distributed in a width direction of the multi-mode waveguide. The array units are arranged at an interval of 3 μm in a length direction and are uniformly distributed in a length direction of the multi-mode waveguide. A random quantity is respectively loaded on a transverse and longitudinal position of each defect scattering unit of this array and the size of the defect, so that this array becomes a rectangular random array with random size and random distribution. The position of each basic unit has a random quantity in the length direction and a random quantity in a width direction respectively, wherein the random quantity of the position in the width direction is (−0.5 μm, 0.5 μm), and the random quantity of the position in the length direction is (−2.8 μm, 2.8 μm).

The random quantity (−0.5 μm, 0.5 μm) refers to a random deviation near array points which are originally regular, and the range of this deviation is in the range of (−0.5 μm, 0.5 μm).

The spherical centers of the defects are all located on the surface of the multi-mode waveguide; each defect is manifested as a hemispherical recess on the surface of the waveguide; and light is scattered from the defect.

In a specific embodiment, the substrates of the single-mode and multi-mode waveguides and a cladding layer are made of silicon dioxide, and an upper layer of the multi-mode waveguide is a silicon dioxide layer with a thickness of 300 nm.

A manufacturing method of the waveguides is plasma-enhanced chemical vapor deposition (PECVD). A manufacturing method of the defect is reactive ion etching (RIE). Gases used for reactive ion etching are SF₆, N₂ and O₂. In dry etching, active free radical molecules and atoms used in etching cause chemical reactions to form volatile substances, while etched substances are stripped off. Free radicals are not affected by the electric field and are in the thermal movement in all directions, etching is isotropic, and required hemispherical defects are not easily obtained.

The photodetector is a CMOS area array sensor. A distance between the CMOS area array sensor and the surface of the multi-mode waveguide is 300 nm. The CMOS area array sensor is laminated together with the silicon dioxide layer on the upper layer of the multi-mode waveguide after protective glass of the CMOS area array sensor is removed.

The spectral reconstruction includes the following step:
in a specific embodiment, a device is calibrated using a continuously adjustable light source. An equation used for calibration is as follows:

$$I ( x ) = \int T ( x , λ ) S ( λ ) d λ .$$

In the above formula:
S(λ) represents a spectral component matrix of input light;
T(x,λ) represents a transmission matrix of the device, i.e., a spectral response matrix of a device to be calibrated; and
I(x) represents a spot intensity matrix obtained at different positions of a detector.

This equation may be expanded to obtain:

$$( \begin{matrix}{T}_{11} & … & {T}_{m 1} \\ ⋮ & ⋱ & ⋮ \\ {T}_{1 n} & … & {T}_{mn}\end{matrix} ) [ \begin{matrix}{S}_{1} \\ ⋮ \\ {S}_{m}\end{matrix} ] = [ \begin{matrix}{I}_{1} \\ ⋮ \\ {I}_{n}\end{matrix} ] .$$

During calibration, monochromatic light Sₘ of the input known wavelength and intensity may obtain the corresponding light intensity distribution I(x) on a photodetector, and components in a T(x,λ) transmission matrix may be calibrated through these two known values. During use, the entire transmission matrix of the device may be obtained by inputting monochromatic light with equal wavelength interval in the operating band range of the device. m is the number of spectral components, and n is the number of pixel elements used in the calculation of the photodetector, m≥n.

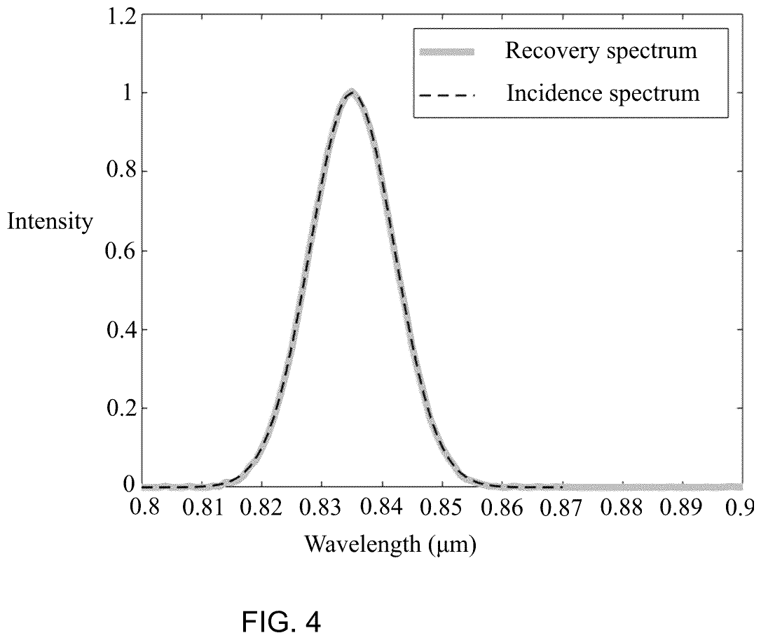

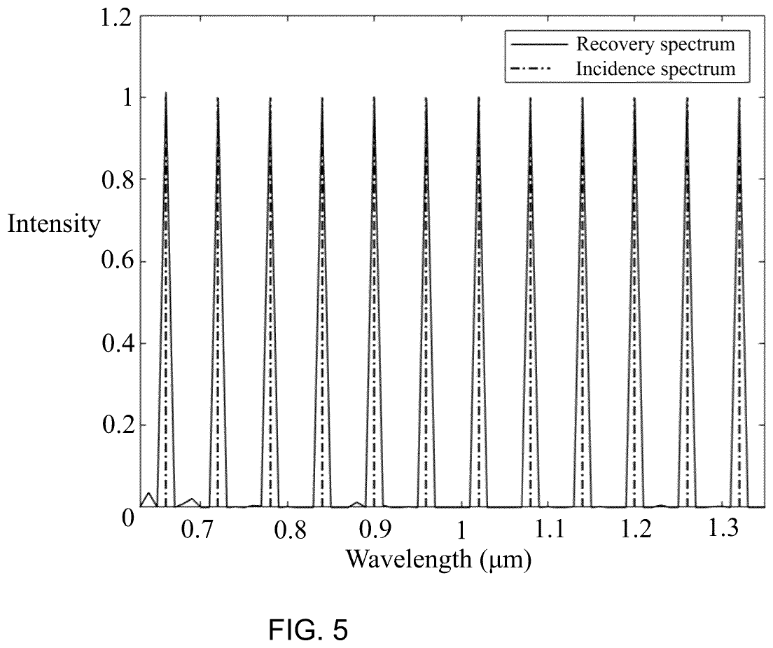

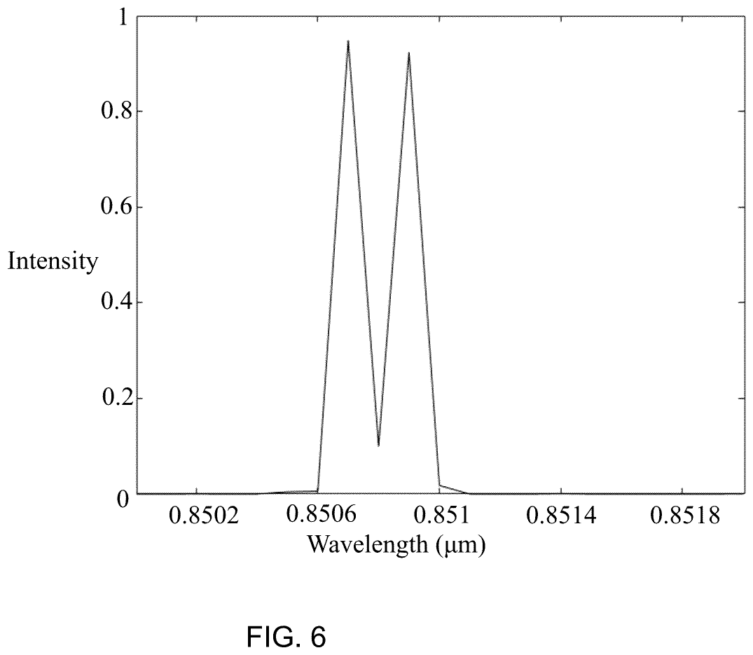

After the calibration of the T(x,λ) transmission matrix is completed, for a re-input unknown spectrum S(λ), a spot intensity distribution function I(x) is obtained on the sensor through side defect scattering of the device. The components of the unknown spectrum may be obtained by solving an equation S=T⁻²I. As shown in FIG. 4, this picture shows a spectral recovery result of the spectrometer on the input signal light, which is the result of the reconstruction of wide-band light with a central wavelength of 830 nm and a spectral half-height width of 15 nm. It can be seen that a target spectral line can be reconstructed well. Simulation experiments are carried out for light in the wavelength range of 0.6-1.4 μm. As shown in FIGS. 5 and 6, it can be seen that the target spectral line in a large bandwidth range can be seen. In addition, the resolution of the spectrometer having two spectral lines with a phase difference of 0.2 nm can be resolved at 850.8 nm.

The device obtained by this method has a wide range of operating bands, high and accurate resolution, small size and compact structure because of no use of a light-splitting device, and require low precision for the process, and is also easy to produce.

The technical scope of the present invention is not limited to the contents of the description, and the above embodiment is only one of the examples given for the purpose of fully expounding the principle and spirit of the present invention. A person skilled in the art to which the present invention belongs can make various changes and modifications to the described method, and the changes and modifications all belong to the protection scope of the present invention.

1. An apparatus for spectrum detection by defect scattering calculation and reconstruction, comprising a photodetector, light input system and a multi-mode waveguide, wherein the surface of the optical waveguide is etched with a random defect scattering structure, and the rest parts are cladding layers; one end of the light input system is connected to a light source, and the other end of the light input system is connected to the optical waveguide; and the photodetector is arranged on the optical waveguide and used for collecting a spot scattered from the random defect scattering structure on the optical waveguide.

2. The apparatus for spectrum detection by defect scattering calculation and reconstruction according to claim 1, wherein the light input system is a structure that stabilizes light after light propagation, so that a spot and power of light inputted into the optical waveguide are stable.

3. The apparatus for spectrum detection by defect scattering calculation and reconstruction according to claim 2, wherein the waveguide is made of a transparent material in an operating band, and silicon nitride, silicon, silicon dioxide, lithium niobate, III-V semiconductor compounds or a polymer material or other material are also used to manufacture the optical waveguide.

4. The apparatus for spectrum detection by defect scattering calculation and reconstruction according to claim 3, wherein the random defect scattering structural unit is of an uneven structure on the side surface of the waveguide and is used for scattering light from the optical waveguide; the defect has a section in any shape; and a three-dimensional shape is manifested as a downward or upward pit or protrusion from the surface of the waveguide.

5. The apparatus for spectrum detection by defect scattering calculation and reconstruction according to claim 4, wherein a spatial position, size and depth of a basic unit of the random defect scattering structure each have a random quantity, or one of them has a random quantity, or a part of the whole quantities has a random quantity; the obtained random defect scattering structure is randomly distributed on the surface of the optical waveguide; and the light propagation in the optical waveguide is scattered through the defect unit.

6. A method for spectrum detection by defect scattering calculation and reconstruction, comprising the following steps:
1) calibration: allowing a number of calibration light of known wavelengths and intensities in a band range to enter a device, the device being the apparatus for spectrum detection by defect scattering calculation and reconstruction according to claim 1, and the light being scattered from the side surface of the optical waveguide to obtain a light field intensity distribution on different pixels of the photodetector; storing light field intensity values obtained by the series of different wavelengths in a transmission matrix as a spectral response function;
2) collection of a scattered light field intensity distribution on the side surface: when light of an unknown spectrum enters the device, the light is scattered from the side surface of the optical waveguide to obtain a light field intensity distribution on the photodetector; and
3) spectral reconstruction: a calibrated transmission matrix and a light field distribution of unknown light form a linear equation, and a spectrum of reconstructed light to be measured is obtained by solving the linear equation.

7. The method for spectrum detection by defect scattering calculation and reconstruction according to claim 6, wherein the photodetector collects an optical signal scattered from the side surface of the optical waveguide.
